(19) United States
(12) Patent Application Publication
(10) Pub. No.: US 2013/0107361 A1
(43) Pub. Date: May 2, 2013

(54) Compound curved stereoscopic eyewear

(71) Applicant: RealD Inc., Beverly Hills, CA (US)

(72) Inventors: Gary D. Sharp, Boulder, CO (US); David A. Coleman, Louisville, CO (US)

(73) Assignee: REALD INC., Beverly Hills, CA (US)

(21) Appl. No.: 13/714,874

(22) Filed: Dec. 14, 2012

Related U.S. Application Data
(63) Continuation of application No. 13/019,275, filed on Feb. 1, 2011.
(60) Provisional application No. 61/300,396, filed on Feb. 1, 2010.

(51) Int. Cl. G02B 27/26; G02B 5/30

(52) U.S. Cl. CPC G02B 27/26; G02B 5/30
USPC 359/465; 156/306.6; 156/275.5; 359/489.07

(57) ABSTRACT

Stereoscopic eyewear with compound curvature may be employed to view three dimensional content. The manufacture of such eyewear may be achieved by thermoforming a first material and by thermoforming a second material. The first and second materials may be in roll stock form prior to thermoforming, and the first layer may be polarizer material, while the second layer may be retarder material. Each of the first and second materials may be thermoformed by employing optimized thermoforming conditions for each of the two materials. Additionally, the two thermoforming lines may be timed so that the curved shapes of the first material in roll stock form may be substantially synchronized with the curved shapes of the second material in roll stock form, which may allow the curved shapes of each of the first and second materials in roll stock form may be joined together.

### CROSS-REFERENCE TO RELATED APPLICATIONS

This is a continuation application and claims priority to U.S. patent application Ser. No. 13/019,275, filed Feb. 1, 2011, entitled “Compound curved stereoscopic eyewear which claims priority to U.S. Provisional Patent Application Ser. No. 61/300,396, filed Feb. 1, 2010, entitled “Compound curved stereoscopic eyewear,” the entirety of all which are herein incorporated by reference.

### TECHNICAL FIELD

The present disclosure generally relates to stereoscopic eyewear, and more specifically, to stereoscopic eyewear with compound curvature.

### BACKGROUND

Stereoscopic imaging involves displaying a pair of images containing three-dimensional (“3D”) visual information to create the illusion of depth in an image. One way to stimulate depth perception in the brain is to provide the eyes of the viewer two different images, representing two perspectives of the same object, with a minor deviation similar to the perspectives that both eyes naturally receive in binocular vision. Many optical systems display stereoscopic images using this method. Polarization is frequently used as a means of delivering specific imagery to each eye, where orthogonal polarization lenses select the appropriate image. The illusion of depth can be created in a photograph, movie, video game, or other two-dimensional (“2D”) image.

### BRIEF SUMMARY

According to the present disclosure, a method for providing an optically polarized material may include thermoforming a first material by employing optimized thermal conditions for the first material, thermoforming a second material by employing optimized thermal conditions for the second material, and assembling the thermoformed first material and the thermoformed second material such that a first side of the thermoformed first material is in contact with a first side of the thermoformed second material. Further, thermoforming the first and second material may be performed substantially simultaneously. The method may include forming the first material and second material into substantially curved surfaces and may also include laminating the two materials together. The two materials may be laminated together by depositing an adhesive onto at least a first surface of the thermoformed first material. The adhesive may be cured by employing an ultraviolet light source. Additionally, assembling the first material and the second material may induce minimal differential stress between the first and second materials. A third material may also be thermoformed and may be joined to at least a second side of the first material, wherein the third material may provide a substantially optimized surface quality. Any individual, in combination or all of the first, second and/or third materials may be in roll stock form or any other appropriate material form such as sheet form. The method may include providing a corona treatment at least to the first side of the first material. In one embodiment, the first material may be a linear polarizer and the second material may be a retarder. Continuing the embodiment, the retarder may be a cyclo olefin copolymer material and the linear polarizer may be a polyvinyl acetate material.

According to another aspect, the present application discloses a method for providing a lens with compound curvature. The method may include thermoforming a polarizer, thermoforming a retarder and assembling the polarizer and retarder while substantially maintaining an approximate retardation value, wherein a first side of the polarizer may be in contact with a first side of the retarder. Thermoforming the retarder may be performed at a substantially optimized thermal process for the retarder and thermoforming the polarizer may be performed at a substantially optimized thermal process for the polarizer. The method may also include forming both the polarizer and retarder into a series of substantially curved surfaces and may include laminating the polarizer and the retarder together. The polarizer and retarder may be in roll stock or sheet form.

Disclosed in the present application is an optically polarized material with compound curvature, which may include a first thermoformed layer which may be formed using a first set of optimized thermal conditions for the first thermoformed layer and a second thermoformed layer which may be formed using a second set of optimized thermal conditions for the second thermoformed layer, wherein the first and second thermoformed layers may be joined by an adhesive. The optically polarized material may include a plurality of substantially curved surfaces. An adhesive may be employed to laminate the first thermoformed layer and the second thermoformed layer together and an adhesive may be deposited onto at least a first surface of the first thermoformed layer. The adhesive may be cured by employing an ultraviolet light source. The first thermoformed layer and the second thermoformed layer may be thermoformed substantially simultaneously. The first and second thermoformed layers may be processed as any material form as appropriate including, but not limited to, roll stock, sheet form and so on.

These and other advantages and features of the present disclosure will become apparent to those of ordinary skill in the art upon reading this disclosure in its entirety.

### BRIEF DESCRIPTION OF THE DRAWINGS

Embodiments are illustrated by way of example in the accompanying figures, in which like reference numbers indicate similar parts, and in which:

FIG. 1 is a flow diagram illustrating an embodiment of a process for manufacture eyewear with curved lenses in accordance with the present disclosure;

FIG. 2 is a schematic diagram illustrating an embodiment of a set of eyewear in accordance with the present disclosure;

FIG. 3 is a schematic diagram illustrating an embodiment of a process in accordance with the present disclosure;

FIG. 4 is a schematic diagram illustrating a process in accordance with the present disclosure; and

FIG. 5 is a schematic diagram illustrating a cross section of a lens in accordance with the present disclosure.

### DETAILED DESCRIPTION

According to an aspect, a method for providing a polarization analyzing material may include thermoforming a first material by employing optimized thermal conditions for the first material and thermoforming a second material by employing optimized thermal conditions for the second material. The two materials may be processed substantially simultaneously and may be produced in high volume. Additionally, one or both of the first and second materials may be in roll stock form, sheet form, or any other appropriate material form that may allow the processing conditions to be individually optimized for each of the materials. The two process lines may also be synchronized such that curved surfaces of the material of a first line may approximately align with curved surfaces of the material of a second line.

It should be noted that embodiments of the present disclosure may be used in a variety of optical systems and projection systems. The embodiment may include or work with a variety of projectors, projection systems, optical components, computer systems, processors, self-contained projector systems, visual and/or audiovisual systems and electrical and/or optical devices. Aspects of the present disclosure may be used with practically any apparatus related to optical and electrical devices, optical systems, presentation systems or any apparatus that may contain any type of optical system. Accordingly, embodiments of the present disclosure may be employed in optical systems, devices used in visual and/or optical presentations, visual peripherals and so on and in a number of computing environments.

Before proceeding to the disclosed embodiments in detail, it should be understood that the disclosure is not limited in its application or creation to the details of the particular arrangements shown, because the disclosure is capable of other embodiments. Moreover, aspects of the invention may be set forth in different combinations and arrangements to define inventions unique in their own right. Also, the terminology used herein is for the purpose of description and not of limitation.

Eyewear used in the stereoscopic cinema may include a die cut flat sheet of linear or circular polarizer mounted in a plastic frame. Linear polarizers may include conventional liquid crystal display polarizers, which are stretched/dyed polyvinyl alcohol (“PVA”) film laminated between triacetyl cellulose (“TAC”) substrates. The TAC substrates may have no optical function, and may primary be employed to mechanically support and protect the PVA film from the environment. Circular polarizers (“CPs”) may be fabricated by pressure sensitive adhesive (“PSA”) lamination of a stretched polymer quarter-wave retarder to a linear polarizer. The circularly polarized film may be placed into a frame recess, with a secondary frame piece forming a press-fit of the lens material. In one embodiment, mounting arrangements may minimize the perimeter stress, which may be due to a number of issues including pinches (particularly from discrete mounting points), and over constraining the film by rigidly mounting the entire perimeter. These issues may induce birefringence and additionally may impact product performance. This issue may also be apparent for CP eyewear, where a small stress applied to a retarder such as polycarbonate, may induce significant shift in retardation value and optic axis orientation. Such spatially varying behavior may cause a light leakage associated with polarization contrast loss, or cross-talk.

While present cinema eyewear may provide a low-cost solution, issues may exist that may detract from the 3D experience. For example, substrate materials may be conventionally fabricated using an extrusion or casting process, which may yield a surface with undulations that cause irregularity in a transmitted wavefront. Moreover, flat lenses can be mechanically unstable, so they may not lie flat, and may appear wrinkled and distorted after mounting.

Rather than the current flat lenses, it may be desirable to manufacture 3D eyewear lenses with compound curvature, having a desired base curve, but with little to no compromise in 3D contrast. Thermoforming processes have been used to manufacture polarizing sunglasses where both lenses have polarization filters of the same orientation, and in which there is no need to bend a retardation film. Additionally, the polarizing efficiency desired in a 3D lens can be in excess of that required for polarized sunglasses, due to the impact of a small birefringence on the 3D experience.

In one example of a thermoforming process, a disk may be placed into a heated metal form, and may be immediately forced into the cup with the application of a vacuum. For materials with the proper thickness and mechanical properties, the disk may be substantially conformal to the cup. After a prescribed dwell time, the vacuum may be released and the disk may have a compound curvature. In some embodiments, the base curve may be lower than that of the cup, and the geometry may differ significantly from the desired spherical shape. When such a process is used on thin-gauge material, the application of the vacuum may cause wrinkles, and the lens may be thus rendered unserviceable. As such, this vacuum forming process may be most compatible with material of a particular gauge.

There are several issues that may occur when thermoforming planar laminates. Such a stack-up for a 3D lens may include a PVA polarizer, TAC protective sheets, a retarder film, an additional support substrate, and one or more adhesive chemistries. Each material may have different physical properties, such as, but not limited to glass-transition temperature (“Tg”), stress-strain characteristics, modulus, molecular weight, different sensitivities to heat and so on. For instance, a high performance PVA polarizer may typically lose polarizing efficiency when exposed to excessive thermal energy. As such, thermoforming such laminates may result in selecting compromised process parameters, based on, in part, optimal parameters of the various constituent materials. In one example, the maximum process temperature may be limited by a particular material, and this temperature may be significantly below Tg of another material. When such an assembly is thermoformed, the high Tg material can be placed under significant stress, which can impact performance and lead to product failure caused by any number of issues such as delamination.

In some instances, substrates may be included in the stack-up with no particular functionality in the final product. TAC is conventionally added to protect free-standing PVA polarizer, and additional substrates may be included to accommodate the thickness requirements of the thermoforming process. Such substrates add cost and complexity, complicate the thermoforming process by introducing a different chemistry, and can introduce additional birefringence from thermoforming. In one example, materials that enhance product functionality may be incorporated into the lens. In terms of optical functionality, this may include films that may provide increased control of polarization, increased transmission, control of refraction, control of transmission (e.g., photochromics) and/or improve transmitted wavefront.

The present disclosure provides a process for manufacturing compound curved stereoscopic circular polarizing 3D lenses with desired polarization control and/or uniformity, low cost, and high reliability. Some embodiments may include processing polarization functional layers, under conditions substantially optimized for the specific materials used. The lens may then be assembled using a low-stress adhesive. In one embodiment, a web-based assembly process may be used for bonding individual thermoformed layers. A low-temperature process may then be used to form an inner surface, or both inner and (e.g., isotropic) outer surfaces of the finished lens. In this manner, lens assemblies can be made with minimal internal stress, maximizing performance and product lifetime. The “low-temperatures” may be in an approximate range that may not cause significant expansion or contraction of the constituent lens layers or materials such that the final lenses may be rendered unserviceable when performing at approximately room temperature. One example of such an approximate process range may be between approximately 50° F. and approximately 120° F.

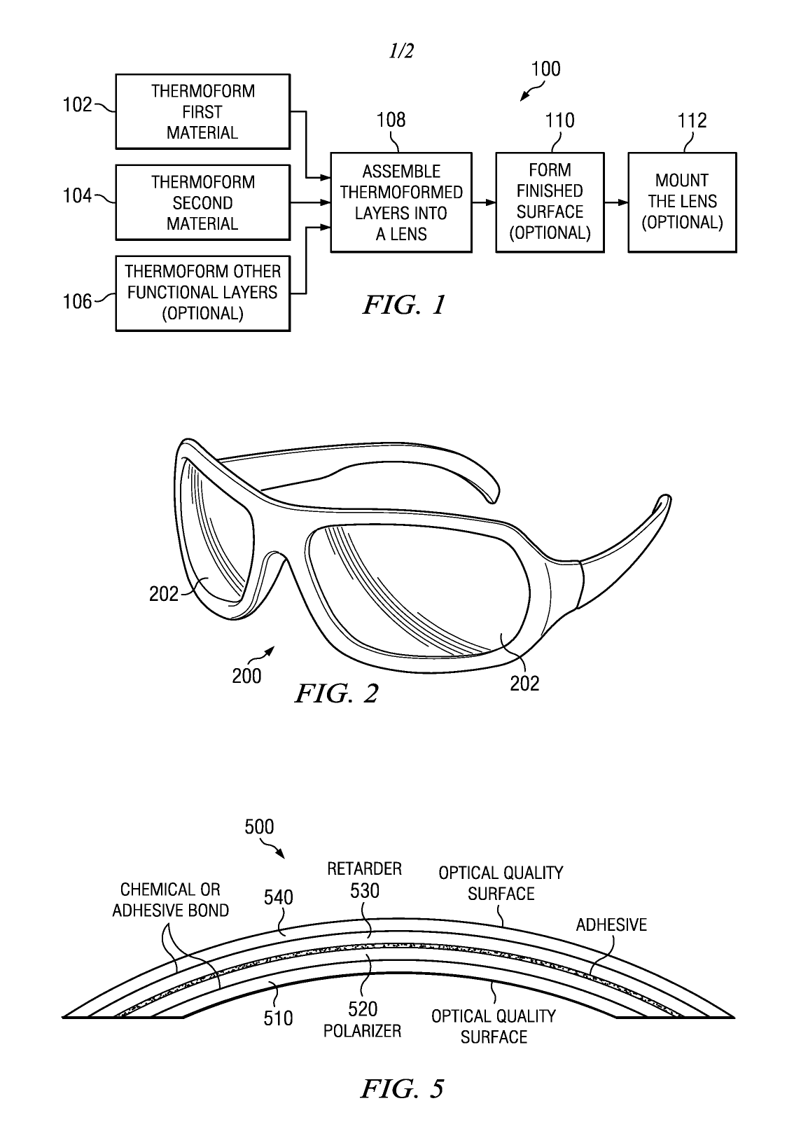

FIG. 1 is a flow diagram illustrating an embodiment of a process for manufacturing eyewear with curved lenses in accordance with the present disclosure. Although the flow diagram includes operations in a specific order, it may be possible to perform the operations in a different order, and it also may be possible to omit operations as necessary. The process 100 in FIG. 1 includes thermoforming a first material in process element 102. The first material may be in roll stock form and may be a polarizer material. The process 100 may include thermoforming a second material in process element 104. The second material may also be in roll stock form and may be a retarder material. Other functional layers may be thermoformed in the optional process element 106. In process elements 102, 104, and 106, each of the thermoforming processes may be carried out under independent conditions optimized for the specific materials used. Additionally, although the first material and second material may be in roll stock form, the process elements 102 and 104 may also process material in any appropriate material form including sheet form, which may allow for each of the materials to be processed under independently optimized conditions.

In one embodiment, process elements 102, 104, and 106 may be carried out simultaneously. The thermoformed curved layers prepared in process elements 102, 104, and 106 may be assembled in process element 108 using a variety of coupling mechanisms, including adhesive lamination. In process element 110, a low-temperature process may be used to form an inner surface, or both inner and (e.g., isotropic) outer surfaces of the finished lens. Additionally, process element 108 and 110 may be performed as a single process, or may be separate processes as indicated in FIG. 1. Generally, pre-formed material such as quarter wave retarder and linear polarizer, with or without mechanical support substrates, can be placed into an insert-mold, where they may be substantially simultaneously joined and encapsulated in resin. In process element 112, the finished lens is mounted onto stereoscopic eyewear in accordance to the present disclosure.

FIG. 2 is a schematic diagram illustrating an embodiment of a set of eyewear in accordance with the present disclosure. FIG. 2 is a schematic view of stereoscopic eyewear 200, which may include curved lenses 202. The curved lenses 202 may be suitable for cinematic viewing and may be manufactured according to the process 100 illustrated in FIG. 1 or any other processes in accordance with the principles of the present disclosure. The curved lenses 202 may be uniformly curved across the lens or the curvature may vary across the curved lenses 202.

The present disclosure further provides for the utilization of materials that may be suitable for preserving desired polarization control properties through the thermoforming process. As described in the commonly-assigned U.S. patent appl. Ser. No. 12/249,876 (herein incorporated by reference), Cyclic Olefin Copolymer (COC) may be a low elasticity retarder. Thermoformed COC articles are described in U.S. Pub. Patent Appl. No. 2008/0311370, which is hereby incorporated by reference and includes references to COC materials and processing. Relatively high tension may be used to induce a particular linear retardation in a COC film, due to low stress-optic coefficient, and as such, it is relatively immune to subsequent changes due to thermoforming. The radial stress applied during thermoforming can otherwise cause spatial nonuniformity in polarization control. Due to the relatively high Tg value of many COC products, it is difficult to optimize the thermoforming temperature of COC when built into a stack-up, as the laminate is likely to be destroyed. Thus, while COC is a desired retarder film, it may be formed at insufficient temperature, which places the stack-up under a permanent mechanical load.

An alternative is to use a material that can be formed at a lower processing temperature. As described in the commonly-assigned U.S. patent appl. Ser. No. 12/249,876, common display retardation films fabricated with materials such as polycarbonate may show dramatic change in the spatial distribution of retardation and optic axis orientation as a consequence of the thermo-forming process. The magnitude of this nonuniformity may be too large to meet the desired contrast uniformity in 3D eyewear. This is particularly so for high base curve values, where most vendors require fielding a base-8 product line (e.g., eyewear styles containing base-8 lenses). Polycarbonate based thermoformed lens products may thus be limited to relatively small base curves due to loss in retarder performance.

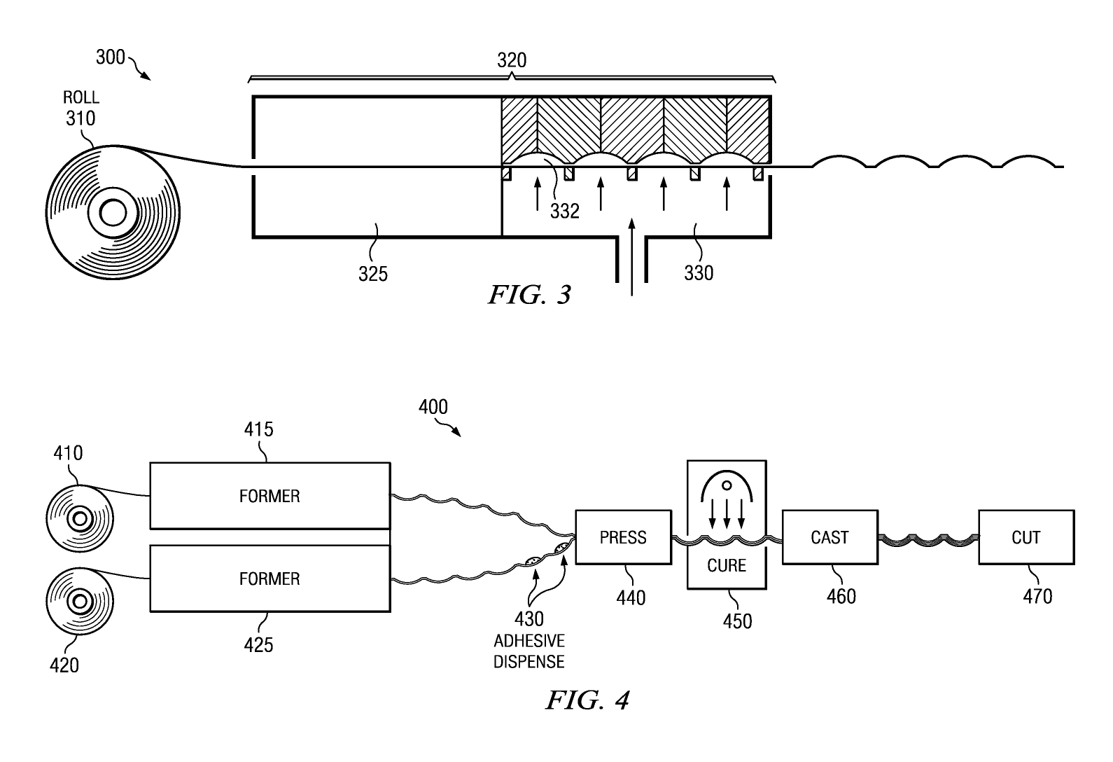

FIG. 3 is a schematic diagram illustrating a process in accordance with the present disclosure. Although the process includes operations in a specific order, it may be possible to perform the operations in a different order, and it also may be possible to omit operations as necessary. FIG. 3 illustrates a thermoforming process suitable for forming curved lenses in accordance to the present disclosure. As shown, a thin-gauge thermoforming process, such as that described in U.S. Pat. No. 6,072,158 and U.S. Pat. No. 5,958,470, which are hereby incorporated by reference, may be used to adiabatically shape the sheet stock into a desired shape. The desired shape may be spherical, toroidal or any other shape that may be determined according to the optimized thermal parameters of a particular material. In FIG. 3, the thermoforming process 300 may include roll stock 310 and a thermoformer 320. In one embodiment and as shown in FIG. 3, the roll stock 310 may enter the thermoformer 320 as a substantially continuous piece of material and may exit the thermoformer 320 as a substantially continuous piece of material. The thermoformer 320 may include a heated area 325 and a forming area 330. The heated area 325 may be any type of chamber capable of substantially controlling the temperature such as an oven. Although the term chamber may be used, this may be a general chamber that may be partially or entirely enclosed, or may be an area with little to no surrounding structure that may enclose the area of interest. Additionally, even though FIG. 3 includes material in roll stock form, roll stock 310 may also be any appropriate material form such as, but not limited to, sheet form, roll stock form and so on.

In FIG. 3, the roll stock 310 may feed into the heated area 325, which may bring the roll stock 310 to an appropriate softening temperature. The appropriate softening temperature may be specific to the roll stock 310 and may vary depending on the individual properties of different types of roll stock 310. The roll stock 310 may then move into the forming area 330. While in forming area 330, the roll stock 310 may be clamped into an array of fixtures 332. The array of fixtures 332 may be any shape such as, but not limited to, spherical, toroidal, ellipsoidal and so on.

As shown in FIG. 3, a differential pressure may be gradually applied to one side of the mold, and the roll stock 310 which may be somewhat uniformly heated, may be gradually driven into openings of the fixture, which may contain a concave mold. The process may be performed in a single oven, where the film/tooling may separate the two or more compartments. The film may be clamped in a frame, where a differential pressure can be applied after the film is up to or substantially at the selected temperature. The pressure (or sag under gravity) may move the film, which may be in a rubbery state, toward and/or into the frame openings. This may pre-stretch the film, similar to blowing a bubble. Such a process may apply differential pressure on the film and may be evenly distributed, which may yield good uniformity. Additionally, a convex tool may then be pushed into the bubble (or array of bubbles) to provide the final geometry. In effect, little to no stretching may take place in this step, as the film may be draped over the mold. The film may contact a mold, and may cease to stretch further, as nonuniformities can result otherwise. In the bubble forming process, the pre-stretched bubble may be inverted onto the mold. An alternative method may be to prestretch the material/film, and then blow it into a concave mold. In general, the approach may be to perform most of the film stretching in the absence of contact with the mold, in order to yield the most uniform result.

Although the mold is depicted in FIG. 3 as concave, the mold may be any shape such as convex, square and so on. This process may allow the material to be subjected to substantially similar thermal conditions spatially and thus may have substantially uniform differential radial stretching. The use of a mold may allow a laminated heat-shield film to be added to the material. As depicted in FIG. 3, the roll stock 310 may exit the forming area 330 and may have a different profile than upon entering the oven 325. Additionally, although the roll stock 310 may have a different profile after exiting the oven 325, the roll stock may still be a continuous piece of material. Further, the roll stock 310 exiting the oven 325 may be substantially continuously attached to the roll stock 310 at the beginning of the process. Alternatively, the formed pieces can be cut in place and collected for subsequent lamination on a part-by-part basis.

FIG. 4 is a schematic diagram illustrating a process in accordance with the present disclosure. Although the process includes operations in a specific order, it may be possible to perform the operations in a different order, and it also may be possible to omit operations as necessary. FIG. 4 is another embodiment of a process 400 for the forming curved lenses. In the embodiment of FIG. 4, the functional layers of a circular polarizer (e.g., an iodine PVA polarizer and a COC quarter-wave retarder) may be individually thermoformed according to each of the individual optimized thermal conditions. The functional layers of the circular polarizer may include a polarizer and a retarder. COC may be used as a retarder due to a low stress-optic coefficient, but any material that preserves retardation and optic-axis during thermoforming may be used. Retarders can be either positive or negative uniaxial, but preferably do not have substantial z-retardation. For instance, diacetates typically have a retardation in the thickness that is larger than the in-plane retardation. Coated retarders, such as liquid crystal polymers (by e.g., Rolic), reactive mesogens (by e.g., Merck), and lyotropic liquid crystal polymers (by e.g., Crysoptix) may be alternatives. Coated polarizers, such as those developed by Optiva and Crysoptix, may be employed as PVA polarizer. In one embodiment, the polarizer may be iodine PVA and the retarder may be a COC quarter-wave retarder. The retarder may be any type of material including, but not limited to, COC, acetate, diacetate, polycarbonate, and so on. Additionally, polarizer and retarder of FIG. 4 may be individually thermoformed in parallel manufacturing lines.

As shown in FIG. 4, roll stock 410 and roll stock 420 may feed respectively into former 415 and former 425. Roll stock 410 and 420 may be different types of material and in one embodiment, roll stock 410 may be linear polarizer material and roll stock 420 may be retarder material. As previously discussed, although FIG. 4 includes material in roll stock form, roll stock 410 and 420 may also be any appropriate material form such as, but not limited to, sheet form, roll stock form and so on, which may allow for individually optimizing the processing conditions for each of the materials. Additionally, former 415 and former 425 may include similar components to those of thermoformer 320 of FIG. 3. In one example, former 415 and former 425 may each have a heated area and a forming area.

As shown in FIG. 4, roll stock 410 and 420 may exit former 415 and former 425 and may have a different profile upon exiting than before entering former 415 and former 425. Next, an adhesive dispenser 430 may distribute adhesive onto the formed roll stock 410 and 425. Although the distributed adhesive in FIG. 4 is located on the concave surface of roll stock 420, the distributed adhesive may be located at any number of places on the roll stock 410 and 420, such as, but not limited to, the convex surface of roll stock 410, the concave surface of roll stock 420 and so on.

Next in FIG. 4, the roll stock 410 and 420 may enter a press 440. The press 440 may function to press roll stock 410 and 420 together. In one example, roll stock 410 and 420 may be formed into a desired shape or contour. Continuing this example, the press 440 may bring roll stock 410 and 420 in contact with one another, while substantially maintaining a desired shape and inducing minimal stress. After leaving the press 440, the roll stock 410 and 420 may enter a cure area 450. The curing process may be, but not limited to, ultraviolet (“UV”), thermal, and so on. The roll stock 410 and 420 may enter a casting area 460 and then continue onto a cutting process 470.

In one embodiment of the present disclosure, process 400 may be an in-line process, in which the dwell times may be substantially matched in the two lines, so that the roll stocks or webs may be substantially synchronized. Stated differently, and continuing the embodiment, the tooling of process 400 may be designed such that the radius of curvature of the convex surface of the one roll stock material may be matched to the radius of curvature of the concave surface of the second roll stock material. Laminations may then be achieved by depositing an adhesive into and/or onto one or both of the concave and/or convex surfaces and bringing the surfaces into contact. The two roll stock materials may then be pressed together using a variety of methods, followed by a curing process. The curing process may be UV, thermal, or any number of other method known in the art. In some embodiments, room temperature processes may be employed to minimize internal stress. These internal stresses may result due to a mismatch in coefficients of thermal expansion of the two roll stock materials, and may lock in stress when employing a thermal process. In some embodiments, improved adhesion may be accomplished using corona and/or plasma treatment prior to depositing the adhesive.

Generally, and as described in U.S. Patent Application Publication No. 2009/0097117, which is hereby incorporated by reference, circular polarizer material may include material in which the retarder optic axis is oriented at 45-degrees with respect to the polarizer axis. A web-based process may be employed to generate such circular polarizer material, and may be accomplished by die-cutting either the retarder or polarizer at 45-degrees and splicing sheets to form a roll. In one embodiment and according to the present disclosure, a 45-degree retarder stretcher may be employed, as developed by Polaroid Corporation, and further refined by Nippon Zeon. Rolls of precision 45-degree stretched COC retarder can be procured which may allow the thermoformed polarizer to be joined with the retarder in a web-based manufacturing line. Thermoformed CP laminates may then receive back-end process steps either in-line and as described in further detail below, or may be sheeted for such additional processing.

FIG. 5 is a schematic diagram illustrating a cross section of a lens in accordance with the present disclosure. As shown in FIG. 5, the lens 500 may include multiple layers. The first material 510 and fourth material 540 may be material with optical quality surfaces. Generally, an optical quality surface may be a surface that causes minimal wavefront distortion and substantially maintains a refractive power in transmission. A material with an optical quality surface may be included as part of the lens 500 on either or both of the interior and/or exterior surfaces of the lens 500.

Additionally, FIG. 5 may include a polarizer material 520 and a retarder material 530. As previously discussed, any polarizer may be used for lens 500, which may provide appropriate optical functionality such as PVA, or those discussed herein. Likewise, a retarder may be any type of material that provides appropriate optical functionality such as COC, acetate, diacetate, polycarbonate, and so on. The polarizer material 520 and the retarder material 530 may be joined with an adhesive. As discussed herein, the polarizer material 520 and the retarder material 530 may be in roll stock form. Additionally, the two roll stock materials may then be pressed together using a variety of methods, followed by a curing process. The curing process may be UV, thermal, or any number of other method known in the art. In some embodiments, room temperature processes may be employed to minimize internal stress.

Further, in FIG. 5, the first material 510 and the fourth material 540 may be joined to the polarizer material 520 and the retarder material 530 with a chemical and/or adhesive bond. Any type of chemical or adhesive bond known in the art may be employed to join the materials. Additionally, the first material 510 and the fourth material 540 may function as an isotropic encapsulant.

According to one embodiment of the present disclosure, to further minimize the impact of stress on the lens manufacturing, the bonded polarization functional layers may be placed in a fixture between two optical quality molds, as described in U.S. Patent Publication Application No. 2009/0079934, which is hereby incorporated by reference. A monomer may be injected and may be cured on both sides of the polarization functional layers. This may be a water clear UV curable resin which may have low shrinkage, placing the laminate under minimal strain. Moreover, the cured polymer may be selected to be a material that may be relatively insensitive to mechanical stress. In one example, the cured polymer may have a low stress-optic coefficient. In an embodiment, the process of mounting the lens may substantially minimize pinch points that may otherwise become evident in the lens as local polarization contrast loss.

A benefit of the embodiments of the present disclosure may be the minimal internal stress of the finished lenses described herein. This may allow the performance as-fabricated, and over product lifetime, to be preserved. Depending upon the adhesives used, a product with significant internal stress may not be reliable, exhibiting performance creep. This may include changes in geometry/transmitted wavefront characteristics, loss in polarization contrast, and even catastrophic failure such as delamination.

The optical quality CP lens may include additional layers. These layers may be deposited on eyewear lenses, and may include, but are not limited to, hard-coats, anti-fog coatings, anti-reflection coatings and so on. In one example, resin may not be cast on the outer surface of the lens, and a barrier layer may be included on the outer surface of a COC lens. The barrier layer may protect the lens, which may otherwise be damaged when exposed to finger oils. The semi-finished lenses can then be processed and then may be shaped into desired frames.

Generally, stereoscopic systems may be light starved, so a component may be selected with a specific, predetermined functionality and a higher light throughput. Conventionally, in the sunglass industry, manufacturers may employ high processing temperatures with dye-stuff polarizer in order to avoid bleaching that can occur in iodine type polarizer. This may not result as an issue, as sunglasses typically have a requirement for an approximate range of 10-20% photopic transmission, a variety of polarizer colors, and modest polarizing efficiency needs. Alternatively, 3D cinema may desire the highest transmission at all visible wavelengths of the approximate range of 420-680 nm, with neutral gray appearance, and maximum polarizing efficiency. In one example, iodine polarizers may provide the highest transmission of approximately 5% internal loss along the transmission axis and the highest polarizing efficiency of greater than approximately, 99.9%. Furthermore, iodine polarizers may be inexpensive and may be sourced from many vendors. According to an embodiment of the present disclosure, an iodine polarizer may be thermoformed at a relatively low temperature, while substantially providing the desired base curve with substantially minimal loss in performance. Stated differently, the iodine polarizer may be thermoformed at a temperature below the temperature employed for forming COC retarder.

Additionally, eyewear may be designed to serve the dual purpose of 3D eyewear and sunglasses. In this case, an active dimming component may be included to meet the optimum requirements of each product. In one embodiment a photochromic material and/or coating may be used. Some photochromic materials and/or coating may have a low transmission in the open-state, and may have a high density in the closed-state. According to one embodiment of the present disclosure, the closed-state internal transmission of the photochromic material and/or coating may be in the approximate range of 40-60%, and may have an open-state internal transmission exceeding approximately 95%. In one embodiment, the open state internal transmission may be approximately 99%.

While various embodiments in accordance with the principles disclosed herein have been described above, it should be understood that they have been presented by way of example only, and not limitation. Thus, the breadth and scope of this disclosure should not be limited by any of the above-described exemplary embodiments, but should be defined only in accordance with any claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 CFR 1.77 or otherwise to provide organizational cues. These headings shall not limit or characterize the invention(s) set out in any claims that may issue from this disclosure. Specifically and by way of example, although the headings refer to a “Technical Field,” the claims should not be limited by the language chosen under this heading to describe the so-called field. Further, a description of a technology in the “Background” is not to be construed as an admission that certain technology is prior art to any invention(s) in this disclosure. Neither is the “Summary” to be considered as a characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings set forth herein.

What is claimed is:

1. A method for providing a lens with compound curvature, the method comprising:
thermoforming a first layer with first predetermined thermoforming conditions;
thermoforming a second layer with second predetermined thermoforming conditions; and
coupling the first and second thermoformed layers;
wherein the first layer comprises linear polarizer material, and wherein the second layer comprises retarder material; and
wherein the first and second thermoformed layers each comprise a compound curvature.

2. The method of claim 1, wherein at least one of the linear polarizer material and the retarder material is in roll stock form prior to thermoforming.

3. The method of claim 1, wherein thermoforming the first layer and second layer further comprises forming the first layer and second layer into substantially curved surfaces.

4. The method of claim 1, wherein assembling the thermoformed first layer and the thermoformed second material further comprises coupling the two materials together with an adhesive.

5. The method of claim 4, wherein coupling the two layers together further comprises curing the adhesive with an ultraviolet light source.

6. The method of claim 1, wherein thermoforming the first and second layers is performed substantially simultaneously.

7. The method of claim 1, wherein forming the first layer and the second layer into a series of curved surfaces further comprises substantially matching the radius of curvature of an approximately convex surfaces of the first layer to the radius of curvature of an approximately concave surfaces of the second layer.

8. The method of claim 7, further comprising substantially synchronizing the processing of the first and second layers so that the approximately convex surfaces of the first layer may be brought into contact with the approximately concave surfaces of the second layer.

9. The method of claim 1, wherein assembling the first layer and the second layer induces minimal differential stress between the first and second layers.

10. The method of claim 1, further comprising thermoforming a third layer.

11. The method of claim 1, wherein the retarder material is a cyclo olefin copolymer material.

12. The method of claim 1, wherein the linear polarizer material is a polyvinyl alcohol material.

13. A method for providing a lens with compound curvature, the method comprising:
thermoforming a polarizer layer;
thermoforming a retarder layer; and
assembling the thermoformed polarizer layer and the thermoformed retarder layer while substantially maintaining an approximate retardation value, wherein a first side of the thermoformed polarizer layer is in contact with a first side of the thermoformed retarder layer;
wherein the thermoformed polarizer and retarder layers each comprise a compound curvature.

14. The method of claim 13, wherein the polarizer layer is thermoformed under conditions optimized for thermoforming the polarizer layer, and wherein the retarder layer is thermoformed under conditions optimized for thermoforming the retarder layer.

15. The method of claim 13, wherein assembling the thermoformed polarizer layer and the thermoformed retarder layer further comprises laminating the polarizer and the retarder together.

16. The method of claim 15, wherein laminating the polarizer and the retarder together further comprises depositing an adhesive onto at least a first surface of the thermoformed polarizer layer.

17. The method of claim 13, wherein thermoforming the polarizer layer and thermoforming the retarder layer are performed substantially simultaneously.

18. The method of claim 17, further comprises substantially synchronizing the thermoforming of the polarizer and the retarder so that the approximately convex surfaces of the polarizer may be brought into contact with the approximately concave surfaces of the retarder.

19. A lens with compound curvature, comprising:
a first thermoformed layer comprising linear polarizer material, the first thermoformed layer formed using first predetermined thermoforming conditions; and
a second thermoformed layer comprising retarder material, the second thermoformed layer formed using second predetermined thermoforming conditions,
wherein the first and second thermoformed layers are coupled with an adhesive.

20. The lens with compound curvature of claim 19, wherein the optically polarized material has a plurality of substantially curved surfaces.

21. The lens with compound curvature of claim 20, wherein the plurality of substantially curved surfaces of the optically polarized material includes a substantially matched radius of curvature of a plurality of approximately convex surfaces of the first thermoformed layer with the radius of curvature of a plurality of approximately concave surfaces of the second thermoformed layer.

22. The lens with compound curvature of claim 19, wherein the first thermoformed layer and the second thermoformed layer is thermoformed substantially simultaneously.

23. The lens with compound curvature of claim 19, wherein the coupled first thermoformed layer and the second thermoformed layer have a minimal differential stress between the first and second thermoformed layers.

24. The lens with compound curvature of claim 19, further comprising a third thermoformed layer.

25. The lens with compound curvature of claim 19, wherein the linear polarizer material comprises polyvinyl alcohol.

26. The lens with compound curvature of claim 19, wherein the retarder comprises a cyclo olefin copolymer.

27. The lens with compound curvature of claim 19, wherein the linear polarizer material has an axis of polarization, wherein the retarder has an axis of retardation, and wherein the axis of polarization is oriented in a range between 43 and 47 degrees to the axis of retardation in a central area of the lens.

28. The lens with compound curvature of claim 19, wherein the first predetermined thermoforming conditions are different from the second predetermined thermoforming conditions.

29. Stereoscopic eyewear for receiving orthogonal circularly polarized light, comprising:
a first lens comprising:
a first thermoformed layer comprising linear polarizer material, the first thermoformed layer formed using first predetermined thermoforming conditions,
a second thermoformed layer comprising retarder material, the second thermoformed layer formed using second predetermined thermoforming conditions,
wherein the first thermoformed layer is coupled to the second thermoformed layer,
wherein the linear polarizer material has an axis of polarization, wherein the retarder has an axis of retardation, and wherein the axis of polarization is fixedly maintained in a range between +43 and +47 degrees to the axis of retardation within a central area of the first lens; and
wherein the first and second thermoformed layers each comprise a compound curvature;
a second lens comprising:
a third thermoformed layer comprising linear polarizer material, the third thermoformed layer formed using the first predetermined thermoforming conditions,
a fourth thermoformed layer comprising retarder material, the fourth thermoformed layer formed using the second predetermined thermoforming conditions,
wherein the third thermoformed layer is coupled to the fourth thermoformed layer,
wherein the linear polarizer material has an axis of polarization, wherein the retarder has an axis of retardation, and wherein the axis of polarization is fixedly maintained in a range between −43 and −47 degrees to the axis of retardation within a central area of the second lens; and
wherein the third and fourth thermoformed layers each comprise a compound curvature; and
a frame to hold the first and second lenses.
